(19) United States
(12) Patent Application Publication
(10) Pub. No.: US 2011/0236761 A1
(43) Pub. Date: Sep. 29, 2011

(54) ELECTRODE PLATE FOR BATTERY AND BATTERY

(76) Inventors: Kazuki ENDO, Osaka (JP); Masato Fujikawa, Osaka (JP)

(21) Appl. No.: 13/037,908

(22) Filed: Mar. 1, 2011

(30) Foreign Application Priority Data
Mar. 29, 2010 (JP) 2010-075363

(51) Int. Cl. H01M 4/66

(52) U.S. Cl. 429/234

(57) ABSTRACT

An insulating resin layer is formed on part of the surface of a current collector of an electrode plate for a battery. The insulating resin layer is formed on at least part of a portion at which a mixture particle is not in contact with the surface of the current collector, in the area in which an electrode mixture layer is formed on the surface of the current collector.

### CROSS-REFERENCE TO RELATED APPLICATION

This application claims priority from Japanese application JP2010-075363 filed on Mar. 29, 2010, the disclosure of which application is hereby incorporated by reference into this application in its entirety for all purposes.

### BACKGROUND

The present invention relates to electrode plates for a battery and batteries having the electrode plate, and relates to techniques for improving safety of the batteries in the event of an internal short circuit.

In recent years, with the downsize and light weight of electronic equipment such as mobile phones or notebook computers, there is a demand to increase the capacities of secondary batteries used as a power supply of the electronic equipment. To respond to such a demand, nonaqueous electrolyte secondary batteries capable of having a high energy density have been widely used. The nonaqueous electrolyte secondary battery includes a positive electrode, a negative electrode, a separator interposed between the positive electrode and the negative electrode, and a nonaqueous electrolyte.

In general, if a short circuit with relatively low resistance occurs in the battery, a large current flows into the short-circuited portion. This accelerates the heat generation in the battery, leading the battery to a state of overheating. To avoid such a phenomenon, various safety measures are taken for the nonaqueous electrolyte secondary batteries having a high energy density, not only from the viewpoint of the fabrication of the batteries, but also from the viewpoint of the structure of the batteries. In general, a separator with a shutdown mechanism in which micropores are closed due to the heat generated by the internal short circuit, thereby terminating the ionic flow, is used. A short circuit current does not flow in such a separator because of the shutdown mechanism. Therefore, the heat generation in the battery stops. However, in the case where greater heat is generated at the short-circuited portion, a meltdown in which the separator is melted and a large pore is formed in the separator, occurs before the shutdown mechanism functions. If short circuits occur in the positive electrode and the negative electrode due to the meltdown, the battery overheats more, which is very unsafe.

In view of this, it is suggested to form a porous membrane made of a heat-resistant resin, such as aramid, on the separator (see Patent Document 1: Japanese Patent Publication No. H09-208736). The heat-resistant resin, such as aramid, does not melt even at a fairly high temperature. Thus, insulation between the positive and negative electrodes may be maintained in any overheated condition according to the technique in Patent Document 1.

Further, a method is suggested in Patent Document 2 (Japanese Patent Publication No. H10-199574) in which a resistor layer having high resistance and made of a mixture of a carbon powder and a polyimide resin is formed on a surface of a current collector, thereby reducing a current flow at the time of a short circuit. As mentioned above, the heat generation in the battery is accelerated if the resistance of the short-circuited portion is low. However, according to the technique in Patent Document 2, the resistance of the short-circuited portion is high even in the event of an internal short circuit, and therefore, overheating of the battery may be reduced.

### SUMMARY

However, according to the conventional technique in Patent Document 1, although the porous membrane made of a heat-resistant resin exhibits high heat resistance, the short circuit condition continues until the separator provided under the porous membrane shuts down. This may increase the short-circuited portion, and results in further overheating.

According to the technique in Patent Document 2, the safety of the battery is improved because the resistance of the internal short-circuited portion is increased by the resistor layer. However, if a resistor layer necessary for ensuring sufficient safety of the battery in the event of a short circuit caused by a foreign object having a large diameter, such as a nail, is provided, the electronic resistance at the interface between the mixture particle and the current collector increases too much. As a result, load characteristic of the battery is reduced.

It is an objective of the present invention to provide a safety-enhanced electrode plate for a battery in which a reduction in load characteristic of the battery is prevented by ensuring the contact between a mixture particle and a current collector, and in which an excessive increase in battery temperature is reduced even in the event of an internal short circuit caused by insertion of a large foreign object such as a nail, and to provide a battery having the electrode plate.

To achieve the above objective, an electrode plate for a battery of the present invention includes a current collector and an electrode mixture layer formed on a surface of the current collector. An insulating resin layer is formed on part of the surface of the current collector. The insulating resin layer is formed on at least part of a portion at which a mixture particle forming the electrode mixture layer is not in contact with the surface of the current collector, in an area in which the electrode mixture layer is formed.

Here, the insulating resin layer has a layer-like structure having a certain thickness. Thus, the term “insulating resin layer” does not include insulating resins scattered on the current collector, such as binder particles simply adhering to the current collector (the binder particles bind particles of the active material together).

In the case where the electrode plate for a battery of the present invention is a positive electrode plate, examples of the mixture particle include a particle of an active material, a binder particle, and a particle of a conductive agent. In the case where the electrode plate for a battery of the present invention is a negative electrode plate, examples of the mixture particle include a particle of an active material and a binder particle.

The “portion at which a mixture particle forming the electrode mixture layer is not in contact with the surface of the current collector” is a portion at which the current collector is exposed and with which the electrolyte comes in direct contact when the battery is assembled.

According to the electrode plate for a battery of the present invention, the mixture particle may be in contact with the current collector via the insulating resin layer.

According to the electrode plate for a battery of the present invention, the insulating resin layer preferably contains an insulating resin whose resistivity is in a range of between 10¹⁰ Ω·cm and 10¹⁹ Ω·cm, both inclusive. The term “resistivity” as used herein refers to resistivity measured according to the method specified in Japanese Industrial Standards (JIS) K6911.

An electrode plate resistance of the electrode plate for a battery of the present invention is preferably in a range of between 1 Ω·cm² and 200 Ω·cm², both inclusive, and more preferably between 1 Ω·cm² and 30 Ω·cm², both inclusive. The term “electrode plate resistance” as used herein is a resistance obtained by the following method in which two electrode plates (same polarity) in which a lead is attached to the current collector are placed one above the other, and a direct current resistance between the leads is measured by a four-terminal method, while applying a pressure of 2 MPa, and the resistance per unit area of one surface of one electrode plate is calculated to obtain the “electrode plate resistance.”

According to the electrode plate for a battery of the present invention, the insulating resin layer is preferably formed on 50% or more but less than 100% of the area in which the electrode mixture layer is formed. Here, “less than 100%” means that the insulating resin is not formed on the entire area in which the electrode mixture layer is formed, and that there is a portion (even a dot-like portion is enough) at which no insulating resin is formed in the area in which the electrode mixture layer is formed.

According to the present invention, the contact between the mixture particle and the current collector is ensured. Thus, it is possible to prevent a reduction in load characteristic of the battery. Further, since the short circuit resistance is high, generation of the Joule heat can be reduced even under a severe condition in which many short circuits occur. The present invention can provide safety-enhanced batteries.

### BRIEF DESCRIPTION OF THE DRAWINGS

FIG. 1 is a vertical cross section of a battery according to one embodiment of the present invention.

FIG. 2 is a schematic cross section of a part of an electrode plate for a battery according to one embodiment of the present invention.

FIG. 3 is a table showing the results of Examples.

### DETAILED DESCRIPTION

An electrode plate for a battery according to the present embodiment includes a current collector and an electrode mixture layer formed on a surface of the current collector, wherein an insulating resin layer is formed on part of the surface of the current collector. The inventors of the present application found that it was possible to significantly increase the resistance of an internal short circuit, while minimizing a reduction in load characteristic of the battery, by forming an insulating resin layer on a surface of a current collector while ensuring conduction between a mixture particle and the current collector. An embodiment of the present invention will be described hereinafter with reference to the drawings. The present invention is not limited to the embodiment described below.

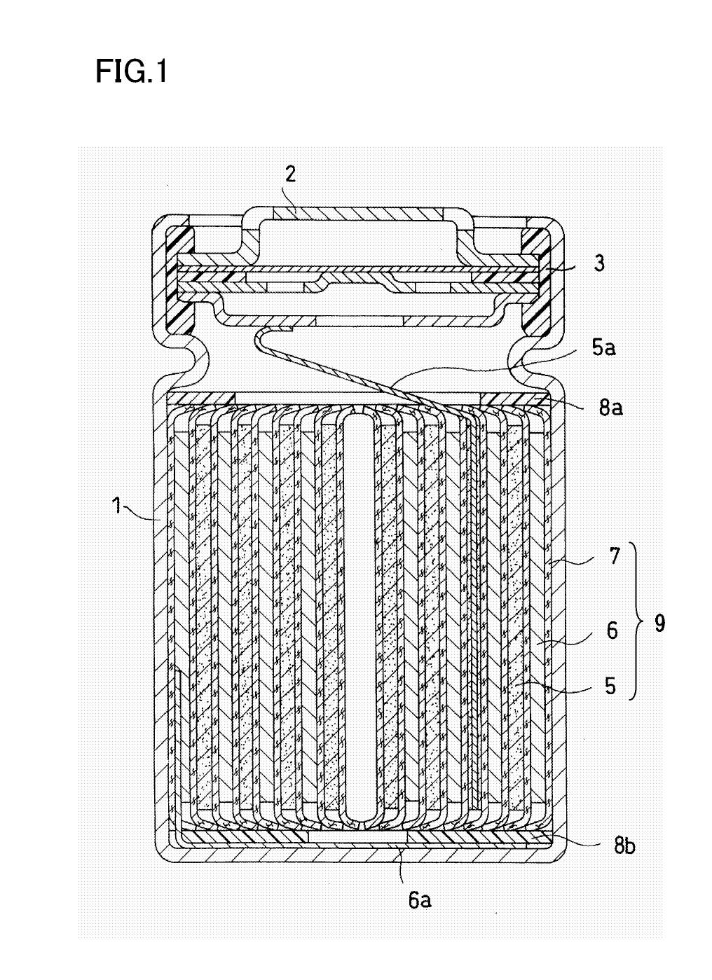

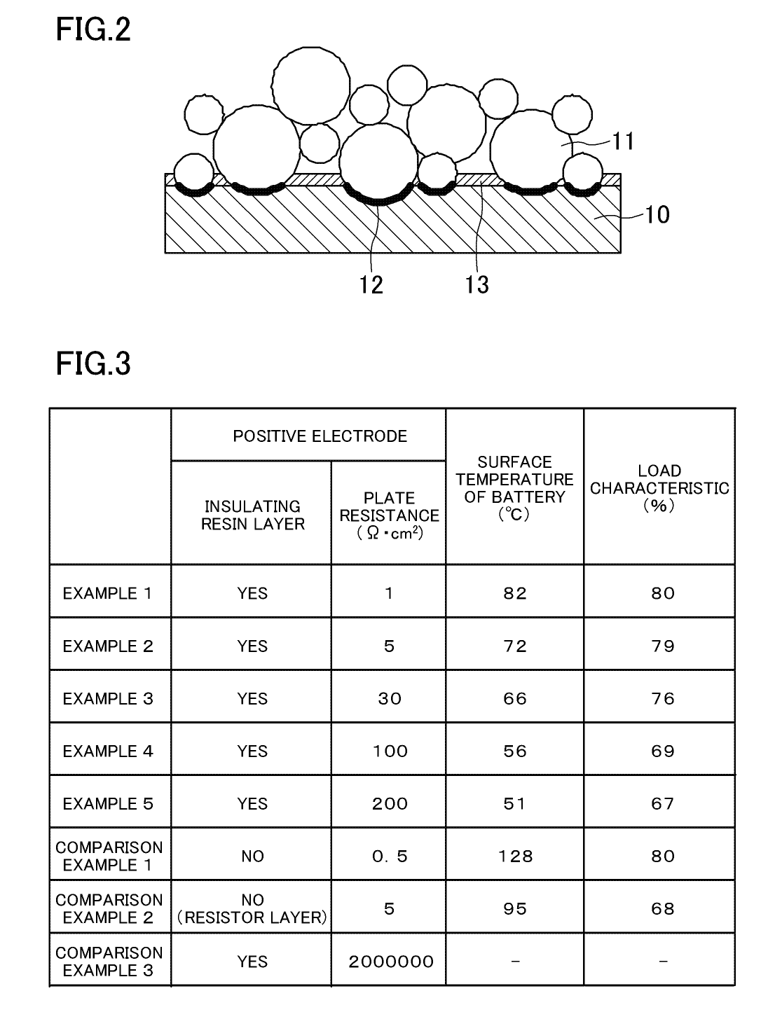

FIG. 1 is a vertical cross section of a nonaqueous electrolyte secondary battery according to the present embodiment. FIG. 2 is a schematic cross section of a part of an electrode plate included in the nonaqueous electrolyte secondary battery according to the present embodiment, for showing a structure of a portion at which a mixture layer (an electrode mixture layer) is formed on the current collector.

As shown in FIG. 1, the nonaqueous electrolyte secondary battery according to the present embodiment includes an electrode group 9 obtained by winding a positive electrode 5 and a negative electrode 6, with a separator 7 interposed between the positive electrode 5 and the negative electrode 6. The electrode group 9 is placed in a battery case 1 together with an electrolyte (not shown). In the battery case 1, the electrode group 9 is sandwiched between an upper insulating plate 8a and a lower insulating plate 8b. The battery case 1 is closed by a sealing plate 2 via a gasket 3, thereby sealing the opening of the battery case 1 and providing electrical insulating between the battery case 1 and the sealing plate 2. The positive electrode 5 is connected to the sealing plate 2 via a positive electrode lead 5a. The negative electrode 6 is connected to the battery case 1 via a negative electrode lead 6a. In the electrode group 9, the positive electrode 5 and the negative electrode 6 may be layered, with the separator 7 interposed therebetween. Further, a current may be collected by a current collector, not by a lead.

As shown in FIG. 2, according to the electrode plate in the present embodiment (i.e., at least one electrode plate of the positive electrode 5 and the negative electrode 6), a mixture particle 11 is in contact with a surface of the current collector 10 via a contact interface 12, which is shown in thick line in FIG. 2. An insulating resin layer 13 is formed on part of the surface of the current collector 10. The insulating resin layer 13 formed on the surface of the current collector 10 can reduce the overheat of the battery because a short circuit resistance is high, even in the case where a foreign object such as a nail is inserted in the battery and an internal short circuit is caused as a result. Further, according to the electrode plate in the present embodiment, the insulating resin layer 13 is not provided uniformly on the entire surface of the current collector 10, but is provided so as to ensure the conduction between the current collector 10 and the mixture particle 11 at the contact interface 12. Thus, it is possible to prevent a reduction in load characteristic of the battery. The insulating resin layer 13 is not provided uniformly on the entire interface between the mixture particle 11 and the current collector 10, but is provided while leaving the contact interface 12 for ensuring the conduction between the current collector 10 and the mixture particle 11. No insulating resin layer 13 is provided at the contact interface 12, or a very thin insulating resin layer 13 is provided at the contact interface 12. Therefore, it is possible to provide conduction between the current collector 10 and the mixture particle 11 at the contact interface 12. Further, the short circuit resistance in the event of an internal short circuit caused, for example, by insertion of a nail is a combined resistance of a short circuit resistance via the mixture particle 11 at the contact interface 12 and a short circuit resistance at a non-contact interface (a portion of the surface of the current collector 10 with which portion the mixture particle 11 is not in contact). In general, a short circuit resistance via the mixture particle 11 is relatively high. Therefore, by increasing a short circuit resistance at the non-contact interface, it is possible to increase the overall short circuit resistance (a short circuit resistance in the event of an internal short circuit caused, for example, by insertion of a nail). In the present embodiment, the insulating resin layer 13 is provided on the non-contact interface. Thus, the short circuit resistance at the non-contact interface is very high. For this reason, it is possible to increase the overall short circuit resistance, thereby significantly reducing the heat generation at a time of a short circuit.

The insulating resin layer 13 may be provided at part of a portion at which the mixture particle 11 is not in contact with the surface of the current collector 10, in the area in which the mixture layer is formed, or as shown in FIG. 2, may be provided at the entire part of the portion at which the mixture particle 11 is not in contact with the surface of the current collector 10, in the area in which the mixture layer is formed.

The method for forming the insulating resin layer 13 is not specifically limited and may be appropriately selected by a person skilled in the art. Examples of the method include coating and electro deposition. Examples of the method for ensuring the contact interface 12 include applying the insulating resin layer 13 to the current collector 10 while leaving a non-application portion (a portion at which no insulating resin layer 13 is provided). Alternatively, an insulating resin and a mixture may be applied to the surface of the current collector 10, and then the current collector 10 may be heated and rolled, thereby softening the insulating resin and having the mixture particle 11 penetrate the insulating resin layer 13.

The material for the insulating resin layer 13 is not specifically limited as long as it is stable in the nonaqueous electrolyte secondary battery, but is preferably a material having a relatively high heat resistance. A resistivity (volume resistivity) of the insulating resin comprising the insulating resin layer 13 is preferably in a range of between 10¹⁰ Ω·cm and 10¹⁹ Ω·cm, both inclusive, and more preferably between 10¹² Ω·cm and 10¹⁹ Ω·cm, both inclusive. For example, polytetrafluoroethylene (PTFE), PolyVinylidene DiFluoride (PVDF), polypropylen, epoxy resin, phenolic resin, aramid resin, or polyimide resin can be preferably used as the insulating resin.

Further, the resistance of the electrode plate having the current collector 10, the insulating resin layer 13, and the electrode mixture layer is preferably in a range of between 1 Ω·cm² and 200 Ω·cm², both inclusive, and more preferably between 1 Ω·cm² and 30 Ω·cm², both inclusive. If the resistance of the electrode plate is lower than 1 Ω·cm², it is sometimes difficult to increase the short circuit resistance in the event of an internal short circuit. As a result, it may not be possible to ensure sufficient safety. On the other hand, if the resistance of the electrode plate is higher than 200 Ω·cm², it is sometimes impossible to ensure the conductance between the current collector 10 and the mixture particle 11. As a result, load characteristic may be reduced.

Further, the insulating resin layer 13 is preferably provided on 50% or more but less than 100% of an area in which the electrode mixture layer is formed. If the insulating resin layer 13 is provided on less than 50% of the area in which the electrode mixture layer is formed, it is sometimes difficult to ensure sufficient safety of the battery in the event of an internal short circuit. If the insulating resin layer 13 is provided on 100% of the area in which the electrode mixture layer is formed, it is sometimes impossible to ensure conduction between the current collector 10 and the mixture particle 11.

Accordingly, the electrode plate for nonaqueous electrolyte secondary battery in the present embodiment has the same structure as the structure of a known electrode plate for nonaqueous electrolyte secondary battery, except that the insulating resin layer 13 is formed at part of the surface of the current collector 10. Structures of the positive electrode 5, the negative electrode 6, the separator 7 and the nonaqueous electrolyte will be briefly described.

In general, the positive electrode 5 includes a positive electrode current collector and a positive electrode mixture layer supported by the positive electrode current collector. The positive electrode mixture layer only needs to contain a binder, a conductive agent, etc. in addition to a positive electrode active material. Examples of the method for forming the positive electrode 5 include preparing a positive electrode mixture slurry by mixing the positive electrode active material, and the binder and the conductive agent, etc., comprised of any components into a liquid component, and applying the obtained positive electrode mixture slurry to the positive electrode current collector and drying the positive electrode mixture slurry. In the case where the positive electrode 5 includes the insulating resin layer 13, the positive electrode 5 has a cross-sectional structure shown, for example, in FIG. 2. That is, the current collector 10 shown in FIG. 2 is a positive electrode current collector; and the mixture particle 11 shown in FIG. 2 is a particle of the positive electrode active material, a particle of the binder in the positive electrode mixture layer, or a particle of the conductive agent in the positive electrode mixture layer.

In general, the negative electrode 6 includes a negative electrode current collector and a negative electrode mixture layer supported by the negative electrode current collector. The negative electrode mixture layer only needs to contain a binder etc. in addition to a negative electrode active material. Examples of the method for forming the negative electrode 6 include preparing a negative electrode mixture slurry by mixing the negative electrode active material and the binder etc. composed of any material into a liquid component, and applying the obtained negative electrode mixture slurry to the negative electrode current collector and drying the negative electrode mixture slurry. In the case where the negative electrode 6 includes the insulating resin layer 13, the negative electrode 6 has a cross-sectional structure shown, for example, in FIG. 2. That is, the current collector 10 shown in FIG. 2 is the negative electrode current collector; and the mixture particle 11 shown in FIG. 2 is a particle of the negative electrode active material or a particle of the binder in the negative electrode mixture layer.

A lithium composite metal oxide can be used as the positive electrode active material. Examples of the lithium composite metal oxide include LiₓCoO₂, LiₓNiO₂, LiₓMnO₂, LiₓCo_{y}Ni_{1-y}O₂, LiₓCo_{y}M_{1-y}O_{z}, LiₓNi_{1-y}M_{y}O_{z}, LiₓMn₂O₄, LiₓMn_{2-y}MyO₄, LiMPO₄, Li₂MPO₄F (M is at least one of Na, Mg, Sc, Y, Mn, Fe, Co, Ni, Cu, Zn, Al, Cr, Pb, Sb, and B), where 0<x≦1.2, 0<y≦0.9, and 2.0≦z≦2.3. Further, “x” which represents a mole ratio of the lithium is a value immediately after the formation of the active material, and increases or decreases due to charge or discharge of the battery. The positive electrode active material may be made of the above lithium composite metal oxides in which part of the metal elements is replaced with a different element. Further, the positive electrode active material may be made of the above lithium composite metal oxides whose surface is treated with a metal oxide, a lithium oxide or a conductive agent, or may be made of the above lithium composite metal oxides whose surface is hydrophobized.

Examples of the negative electrode active material include metal, metal fiber, a carbon material, an oxide, a nitride, a tin compound, a silicide, and various types of alloy materials. Examples of the carbon material include various types of natural graphites, coke, partially graphitized carbon in the process of graphitization, carbon fiber, spherical carbon, various types of artificial graphites, and a carbon material such as amorphous carbon. An elemental substance such as silicon (Si) or tin (Sn), a silicide (e.g., a silicon alloy and a solid solution containing silicon), or a tin compound (e.g., a tin alloy and a solid solution containing tin) is preferably used as the negative electrode active material, because these substances have large capacity density. The silicide may be, for example, SiOₓ (0.05<x<1.95), or may be an alloy, a compound, or a solid solution of SiOₓ (0.05<x<1.95) in which part of Si is replaced with at least one element selected from the group consisting of B, Mg, Ni, Ti, Mo, Co, Ca, Cr, Cu, Fe, Mn, Nb, Ta, V, W, Zn, C, N, and Sn. The tin compound may be Ni₂Sn₄, Mg₂Sn, SnOₓ (0<x<2), SnO₂, or SnSiO₃. As the negative electrode active material, one of the above materials may be solely used, or two or more of the above materials may be combined.

Examples of the binders of the positive electrode 5 and the negative electrode 6 include PVDF, PTFE, polyethylene, polypropylen, aramid resin, polyamide, polyimide, polyamide-imide, polyacrylonitrile, polyacrylic acid, polyacrylic acid methyl ester, polyacrylic acid ethyl ester, polyacrylic acid hexyl ester, polymethacrylic acid, polymethacrylic acid methyl ester, polymethacrylic acid ethyl ester, polymethacrylic acid hexyl ester, polyvinyl acetate, polyvinyl pyrrolidone, polyether, polyether sulphone, hexafluoropolypropylene, styrene-butadiene rubber, and carboxymethyl cellulose. Examples of the binder further include a copolymer made of two or more of the materials selected from tetrafluoroethylene, hexafluoroethylene, hexafluoropropylene, perfluoro alkyl vinyl ether, vinylidene fluoride, chlorotrifluoroethylene, ethylene, propylene, pentafluoropropylene, fluoro methyl vinyl ether, acrylic acid, and hexadiene. The binder may also be formed by combining two or more materials selected from the above materials.

The conductive agents of the positive electrode 5 and the negative electrode 6 may, for example, be graphites such as natural graphite or artificial graphite, may be carbon blacks such as acetylene black, ketjen black, channel black, furnace black, lamp black, or thermal black, may be conductive fiber such as carbon fiber or metal fiber, may be carbon fluoride, may be metal powders such as aluminum, may be conductive whiskers such as zinc oxide or potassium titanate, may be a conductive metal oxide such as a titanium oxide, or may be an organic conductive material such as a phenylene derivative.

The mix proportion of the positive electrode active material, the conductive agent, and the binder in the positive electrode mixture layer is preferably 80-97 weight percent (wt. %) of the positive electrode active material, preferably 1-20 wt. % of the conductive agent, and preferably 1-10 wt. % of the binder.

The mix proportion of the negative electrode active material and the binder in the negative electrode mixture layer is preferably 93-99 wt. % of the negative electrode active material, and preferably 1-10 wt. % of the binder.

The current collector 10 may be a long conductive substrate having a porous structure, or may be a conductive substrate having no pore. Examples of the material for the positive electrode current collector include stainless steel, aluminum, and titanium. Examples of the negative electrode current collector include stainless steel, nickel, and copper. The thickness of the current collector 10 is not specifically limited, but is preferably 1-500 μm, and more preferably 5-20 μm. A lightweight electrode can be achieved, while maintaining the strength of the electrode plate, by setting the thickness of the current collector 10 to the above range.

Examples of the separator 7 include a microporous thin film, woven fabric, and nonwoven fabric which have high ion permeability, a predetermined mechanical strength, and a predetermined insulation property. If polyolefin such as polypropylene or polyethylene is used as a material for the separator 7, it is possible to provide a separator 7 of high durability having a shutdown mechanism. Thus, polyolefin is preferable as a material for the separator 7 to improve the safety of the nonaqueous electrolyte secondary battery. In general, the thickness of the separator 7 only needs to be 10-300 μm. The thickness of the separator 7 is preferably set to 40 μm or less, and more preferably in a range of 15-30 μm, and most preferably in a range of 10-25 μm. The separator 7 may be a single-layer film made of a material of one type, may be a composite film made of two or more types of materials, or may be a multilayer film made of a material of one type. The porosity of the separator 7 is preferably in a range of 30-70%, and more preferably in a range of 35-60%. Here, the term “porosity” is a ratio of volume of the pores to the volume of the separator.

A liquid material, a gel material, or a solid material (e.g., a polymeric solid electrolyte) etc. can be used as a material for the nonaqueous electrolyte.

A liquid nonaqueous electrolyte (nonaqueous electrolyte) can be obtained by dissolving an electrolyte (e.g., lithium salt) in a nonaqueous solvent. A gel nonaqueous electrolyte contains a nonaqueous electrolyte and a polymeric material by which the nonaqueous electrolyte is supported. Preferable examples of the polymeric material include PVDF, polyacrylonitrile, polyethylene oxide, polyvinyl chloride, polyacrylate, and polyvinylidene fluoride hexafluoropropylene.

A known nonaqueous solvent can be used as a material for the nonaqueous solvent in which an electrolyte is dissolved. Types of the nonaqueous solvent are not specifically limited. Examples of the nonaqueous solvent include cyclic carbonate, chain carbonate, and cyclic carboxylate. Examples of the cyclic carbonate include propylene carbonate (PC) and ethylene carbonate (EC). Examples of the chain carbonate include diethyl carbonate (DEC), ethyl methyl carbonate (EMC), and dimethyl carbonate (DMC). Examples of the cyclic carboxylate include gamma-butyrolactone (GBL) and gamma-valerolactone (GVL). As the nonaqueous solvent, one of the above materials may be solely used, or two or more of the above materials may be combined.

Examples of the electrolyte to be dissolved in the nonaqueous solvent include LiClO₄, LiBF₄, LiPF₆, LiAlCl₄, LiSbF₆, LiSCN, LiCF₃SO₃, LiCF₃CO₂, LiAsF₆, LiB₁₀Cl₁₀, lower aliphatic lithium carboxylate, LiCl, LiBr, LiI, chloroborane lithium, borates, and imidates. Examples of the borates include bis(1,2-benzenediolato(2-)-O,O′)lithium borate, bis(2,3-naphthalenediolate(2-)-O,O′)lithium borate, bis(2,2′-biphenyldiolate(2-)O,O′)lithium borate, bis(5-fluoro-2-olate-1-benzenesulfonate-O,O′)lithium borate. Examples of the imidates include lithium bistrifluoromethanesulfonate imide ((CF₃SO₂)₂NLi), lithium trifluoromethanehoussulfonate nonafluorobutanesulfonate imide (LiN(CF₃SO₂)(C₄F₉SO₂)), and lithium bispentafluoroethanesulfonate imide ((C₂F₅SO₂)₂NLi). As the electrolyte include, one of the above materials may be solely used, or two or more of the above materials may be combined.

The nonaqueous electrolyte may contain, as an additive, a material which is decomposed on the negative electrode and forms a coating having high lithium ion conductivity to enhance the charge-discharge efficiency. Examples of the additive having such a function include vinylene carbonate (VC), 4-methylvinylene carbonate, 4,5-dimethylvinylene carbonate, 4-ethylvinylene carbonate, 4,5-diethylvinylene carbonate, 4-propylvinylene carbonate, 4,5-dipropylvinylene carbonate, 4-phenylvinylene carbonate, 4,5-diphenilvinylene carbonate, vinyl ethylene carbonate (VEC), and divinylethylene carbonate. As the additive, one of the above materials may be solely used, or two or more of the above materials may be combined. Among the above materials, the additive is preferably at least one selected from the group consisting of vinylene carbonate, vinyl ethylene carbonate and divinylethylene carbonate. The additive may be made of the above materials in which part of hydrogen atoms is replaced with a fluorine atom. The amount of the electrolyte dissolved in the nonaqueous solvent is preferably in a range of 0.5-2 mol/L.

Further, the nonaqueous electrolyte may contain a known benzene derivative which is decomposed during overcharge and forms a coating on the electrode to inactivate the battery. Examples of the benzene derivative include a phenyl group and a cyclic compound group adjacent to the phenyl group. Preferred examples of the cyclic compound group include a phenyl group, a cyclic ether group, a cyclic ester group, a cycloalkyl group, and a phenoxy group. Examples of the benzene derivative include cyclohexylbenzene, biphenyl, and diphenyl ether. As the known benzene derivative, one of the above materials may be solely used, or two or more of the above materials may be combined. Here, the content of the benzene derivative is preferably 10% or less of the entire volume of the nonaqueous solvent.

Examples and comparison examples are provided hereinafter to describe the present invention. The present invention is not limited to the following examples.

### Embodiments

### 1. Method For Fabricating Battery

### Example 1

### (1) Fabrication of Positive Electrode 5

A polypropylen water-dispersed liquid was applied to both surfaces of an aluminum current collector having a thickness of 15 μm, and thereafter the polypropylen water-dispersed liquid was dried, thereby forming an insulating resin layer 13 on the both surfaces of the aluminum current collector. The coating weight of the polypropylen water-dispersed liquid was about 0.1 mg/cm.

A positive electrode mixture slurry was prepared by agitating 3 kg of a lithium cobalt oxide, 1 kg of an N-methylpyrrolidone (hereinafter referred to as “NMP”) solvent containing 12 wt. % of PVDF (product name: PVDF#1320 produced by KUREHA CORPORATION), 90 g of acetylene black, and a proper amount of NMP using a double arm mixer. This positive electrode mixture slurry was applied to the both surfaces of the aluminum current collector on which the insulating resin layer 13 was formed, and thereafter the positive electrode mixture slurry was dried, thereby forming a positive electrode mixture layer on the aluminum current collector.

After that, the electrode plate was rolled until the overall thickness of 175 μm was achieved by applying a linear pressure of 1.8 t/cm using a roll heated to a temperature of 130° C. The mixture particle 11 was made to penetrate the insulating resin layer 13 by this heat rolling. Thus, the mixture particle 11 came in contact with the aluminum current collector, and a contact interface 12 was formed. A resistance of the electrode plate obtained this way was measured, and the resistance was 1 Ω·cm². This electrode plate was cut to a width of 56 mm and a length of 600 mm to obtain a positive electrode 5. One end of an aluminum lead was connected to a portion of the positive electrode 5 at which the positive electrode current collector was exposed.

### (2) Fabrication of Negative Electrode 6

A negative electrode mixture slurry was prepared by agitating 3 kg of an artificial graphite, 75 g of an aqueous dispersion liquid (product name: BM-400B produced by ZEON CORPORATION) containing 40 wt. % of a styrene-butadiene rubber particle, 30 g of carboxymethylcellulose, and a proper amount of water using a double arm mixer. This negative electrode mixture slurry was applied to both surfaces of the negative electrode current collector made of copper foil and having a thickness of 10 μm, and thereafter the negative electrode current collector was dried. Then, the negative electrode current collector was rolled until the overall thickness of 180 μm was achieved. The electrode plate obtained this way was cut to a width of 57.5 mm and a length of 650 mm to obtain a negative electrode 6. One end of a nickel lead 6a was connected to a portion of the negative electrode 6 at which the negative electrode current collector was exposed.

### (3) Preparation of Electrolyte

A nonaqueous electrolyte was prepared by dissolving LiPF₆, in a concentration of 1 mol/L, in a solvent mixture of EC and EMC in a volume ratio of 1:3.

### (4) Assembly of Battery

A separator 7 (a single layer having a thickness of 20 μm and made of a polyethylene resin) was interposed between the positive electrode 5 and the negative electrode 6 which were fabricated according to the above methods. Then, the positive electrode 5, the negative electrode 6, and the separator 7 were wound, thereby forming an electrode group 9. An upper insulating plate 8a and a lower insulating plate 8b were placed at the respective ends of the electrode group 9 along a longitudinal direction, for housing the electrode group 9 in a closed-end cylindrical battery case 1 having a diameter of 18 mm, a height of 65 mm, and an inner diameter of 17.85 mm. The other end of the aluminum lead 5a was connected to a lower surface of a positive electrode terminal. The other end of the nickel lead 6a was connected to an inner bottom surface of the battery case 1. After that, 5.5 g of the above-described nonaqueous electrolyte was injected in the battery case 1. A sealing plate 2 which supports the positive electrode terminal was fitted to the opening of the battery case 1 via a gasket 3, thereby sealing the battery case 1. Consequently, a cylindrical nonaqueous electrolyte secondary battery whose design capacity is 2000 mAh was fabricated. This battery is a battery of Example 1.

### Examples 2-5

Batteries of Examples 2-5 were fabricated according to the same method for fabricating the battery of Example 1, except that the coating weight of the insulating resin was changed such that the resistance of the positive electrode after rolling would be 5 Ω·cm², 30 Ω·cm², 100 Ω·cm², or 200 Ω·cm².

### Comparison Example 1

A battery of Comparison Example 1 was fabricated according to the same method for fabricating the battery of Example 1, except that the positive electrode was fabricated by rolling in a room temperature without forming an insulating resin layer. The resistance of the positive electrode after rolling was 0.5 Ω·cm².

### Comparison Example 2

A battery of Comparison Example 2 was fabricated according to the same method for fabricating the battery of Example 1, except that the positive electrode was fabricated by rolling in a room temperature after a resistor layer (a mixture of a carbon powder and a polyimide resin) of Patent Document 2, not the insulating resin layer 13, was formed in a thickness of 2 μm on the surface of the aluminum current collector. The resistance of the positive electrode after rolling was 5 Ω·cm².

### Comparison Example 3

A battery of Comparison Example 3 was fabricated according to the same method for fabricating the battery of Example 1, except that the positive electrode was fabricated in a room temperature by applying a linear pressure of 1.0 t/cm. The resistance of the positive electrode after rolling was about 2 MΩ·cm².

### 2. Method For Evaluating Battery

A nail insertion test and a charge-discharge test described below were given to each of the batteries of Examples 1-5 and Comparison Examples 1-3 to evaluate safety and load characteristic of each battery.

### (Nail Insertion Test)

The batteries of Examples 1-5 and Comparison Examples 1-3 were charged under the conditions below. Then, in an atmosphere of 20° C., an iron nail having a diameter of 2.7 mm was inserted into the charged battery from a side surface of the charged battery to a depth of 2 mm at a speed of 5 mm per second, thereby causing an internal short circuit. After 30 seconds from the nail insertion, the temperature of the battery was measured using a thermocouple placed at a side surface apart from the nail insertion portion. The result is shown in “SURFACE TEMPERATURE OF BATTERY” in FIG. 3.

### Conditions of Charge

Constant Current Charge: at a current value of 1400 mA until the voltage of 4.3 V

Constant Voltage Charge: at a voltage value of 4.3 V until the current of 100 mA

### (Charge-Discharge Test)

Each of the batteries of Examples 1-5 and Comparison Examples 1-3 was charged or discharged in an atmosphere of 20° C. under the conditions below. The discharge capacities at the time of discharge of 0.2 C and at the time of discharge of 3 C were checked for each of the batteries. The percentage (%) of the discharge capacity at the time of discharge of 0.2 C to the discharge capacity at the time of discharge of 3 C was calculated to obtain load characteristic. The result is shown in “LOAD CHARACTERISTIC” in FIG. 3.

### Conditions of Charge-Discharge

Constant Current Charge: at a current value of 1400 mA until the voltage of 4.2 V

Constant Voltage Charge: at a voltage value of 4.2 V until the current of 100 mA

Constant Current Discharge: at a current value of 400 mA (0.2 C) until the voltage of 3.0 V

Constant Current Charge: at a current value of 1400 mA until the voltage of 4.2 V

Constant Voltage Charge: at a voltage value of 4.2 V until the current of 100 mA

Constant Current Discharge: at a current value of 6000 mA (3 C) until the voltage of 3.0 V

### 3. Consideration

According to the battery of Comparison Example 1, no insulating resin layer was provided. Therefore, the surface temperature of the battery significantly increased as a result of overheat due to an increase of the short-circuited portion.

According to the battery of Comparison Example 2, the resistor layer of Patent Document 2 was used in replace of the insulating resin layer. Thus, although the surface temperature of the battery was lower than the surface temperature of the battery of Comparison Example 1, the load characteristic of the battery was significantly reduced.

According to the battery of Comparison Example 3, an insulating resin layer was provided. However, the electrode to be a positive electrode was rolled in a room temperature. Thus, the electrode resistance was significantly high, and it was impossible to charge or discharge the battery. The following may be a reason for this: almost no insulating resin was softened because the rolling was performed in a room temperature by applying a relatively low linear pressure; consequently, almost no mixture particles penetrated the insulating resin layer by rolling. For this reason, it was difficult to form the contact interface and ensure conduction between the current collector and the mixture particle.

On the other hand, according to the batteries of Examples 1-5, the electrode resistances are extremely low compared to the electrode resistance of the battery of Comparison Example 3. From this, it is clear that a contact interface is formed in the batteries. Further, according to the batteries of Examples 1-5, the load characteristic was not much reduced, and an increase in surface temperatures of the batteries was very small. The reason why a reduction in load characteristic was reduced is that a contact interface is formed in the batteries of Examples 1-5 and therefore that conduction is ensured between the current collector 10 and the mixture particle 11. Further, the reason why an increase in surface temperatures of the batteries was reduced is that in the batteries of Example 1-5, an insulating resin layer is provided on the surface of the current collector at the non-contact interface, and therefore that it is possible to increase the short circuit resistance at the time of nail insertion.

However, according to the batteries of Examples 4 and 5, a reduction in load characteristic was slightly large maybe because of slightly insufficient conduction between the current collector and the mixture particle at the contact interface. Thus, the resistance of the electrode plate having an insulating resin layer is more preferably in a range of between 1 Ω·cm² and 30 Ω·cm².

What is claimed is:

1. An electrode plate for a battery, comprising:
a current collector; and
an electrode mixture layer formed on a surface of the current collector, wherein
an insulating resin layer is formed on part of the surface of the current collector, and
the insulating resin layer is formed on at least part of a portion at which a mixture particle forming the electrode mixture layer is not in contact with the surface of the current collector, in an area in which the electrode mixture layer is formed.

2. The electrode plate for the battery of claim 1, wherein the insulating resin layer contains an insulating resin whose resistivity is in a range of between 10¹⁰ Ω·cm and 10¹⁹ Ω·cm, both inclusive.

3. The electrode plate for the battery of claim 1, wherein an electrode plate resistance is in a range of between 1 Ω·cm² and 200 Ω·cm², both inclusive.

4. The electrode plate for the battery of claim 1, wherein the insulating resin layer is formed on 50% or more but less than 100% of the area in which the electrode mixture layer is formed.

5. A battery comprising the electrode plate for the battery of claim 1.
